(19) United States
(12) Patent Application Publication
(10) Pub. No.: US 2016/0098735 A1
(43) Pub. Date: Apr. 7, 2016

(54) MARKETING CHANNEL ATTRIBUTION

(71) Applicant: ADOBE SYSTEMS INCORPORATED, San Jose, CA (US)

(72) Inventors: Ritwik Sinha, Kolkata (IN); Shiv Kumar Saini, Rajasthan (IN); Anandhavelu N, Tirupur District (IN)

(73) Assignee: ADOBE SYSTEMS INCORPORATED, San Jose, CA (US)

(21) Appl. No.: 14/508,141

(22) Filed: Oct. 7, 2014

(51) Int. Cl. G06Q 30/02

(52) U.S. Cl. CPC G06Q 30/0202; G06Q 30/0241

(57) ABSTRACT

Techniques are disclosed for evaluating the incremental effect of a marketing channel that forms part of a multichannel marketing campaign. In one implementation data characterizing observed marketing interactions and outcomes is collected. A conversion probability is estimated as a function of the observed interactions using logistic regression techniques, wherein converting and non-converting consumers comprise the two classes upon which the regression is based. As a result, marketing interactions that are relatively more commonplace amongst converting consumers (as compared to non-converting consumers) receive greater attribution for observed conversions. The estimated conversion probability is then used to predict an incremental quantity of conversions that can be attributed to a kth marketing channel based on the average treatment effect. Based on these predictions, it is possible to evaluate the extent to which market segment variables influence how attribution is distributed amongst various marketing channels.

### FIELD OF THE DISCLOSURE

This disclosure relates generally to marketing research, and more specifically to techniques for evaluating the incremental effect of a marketing channel that forms part of a multichannel marketing campaign.

### BACKGROUND

Marketing involves communicating the value of a product or service to consumers for the purpose of selling or otherwise promoting the product or service. A marketing campaign can therefore be understood as comprising various communications which are directed to the public at large or to a smaller target audience. These communications are delivered via one or more marketing channels. A simple marketing campaign might use only one or two channels, such as pamphlet distribution and/or direct mail solicitation. However, evolving technology has resulted in increasingly sophisticated multichannel marketing campaigns. For example, the advent of radio and television has allowed marketers to develop creative audio and/or visual messages that can be delivered to consumers in the privacy of their own homes. The emergence of the Internet has enabled marketers to deliver interactive and personalized campaign messages via multiple platforms, thus making it easier for marketers to craft messages that are specifically tailored to a particular audience or even a particular consumer. Internet-based marketing channels also facilitate the process of tracking consumer response, if any, to specific marketing communications. In particular, digital marketing techniques have made it possible for a marketer to record and evaluate a wide range of interactions that occur between marketers and consumers, thereby providing data upon which the overall efficacy of a marketing campaign can be evaluated.

### BRIEF DESCRIPTION OF THE DRAWINGS

FIG. 1 is a block diagram schematically illustrating selected components of an example networked computer system capable of evaluating the incremental effect of a marketing channel that forms part of a multichannel marketing campaign.

FIG. 2A is a flowchart illustrating a first example method for evaluating the incremental effect of a marketing channel that forms part of a multichannel marketing campaign.

FIG. 2B is a flowchart illustrating a second example method for evaluating the incremental effect of a marketing channel that forms part of a multichannel marketing campaign.

FIG. 3A consists of two bar charts illustrating order attribution for various marketing channels that comprise a multichannel marketing campaign, wherein the order attribution is determined based on a data driven attribution model in a first bar chart, and is based on a last touch attribution model in a second bar chart.

FIG. 3B consists of two bar charts illustrating revenue attribution for various marketing channels that comprise a multichannel marketing campaign, wherein the revenue attribution is determined based on a data driven attribution model in a first bar chart, and is based on a last touch attribution model in a second bar chart.

FIG. 4A is a bar chart illustrating the extent to which various market segment variables influence how attribution is distributed amongst marketing channels defined by such variables, wherein such influence is measured by the Akaike information criterion.

FIG. 4B consists of four bar charts illustrating order attribution for various marketing channels that comprise a multichannel marketing campaign, wherein the order attribution is limited to particular market segments that are defined by a consumer's mobile operating system.

### DETAILED DESCRIPTION

The increasing sophistication of multichannel marketing campaigns has resulted in a corresponding increase in the complexity involved in understanding how different marketing activities influence consumer behavior. For example, a consumer may encounter multiple advertisements for the same product, each delivered via a different marketing channel, before finally deciding to make a purchase from a marketer. These encounters may be spread out over a period of days, weeks, or longer. Adding to this complexity, the consumer may also interact with the marketer in ways not specifically associated with the marketing campaign, such as by having made a prior purchase or by making an unsolicited phone inquiry. Each of these marketer-consumer interactions, regardless of whether specifically associated with the marketing campaign, has the potential to affect the consumer's behavior in a particular way. Even where interactions can be individually tracked in a straightforward manner, such as in the realm of digital marketing, the marketer will still find it difficult to efficiently allocate resources without a clear understanding of how the observed interactions influence consumer behavior.

A number of analytical techniques have been applied to better understand how interactions between a marketer and a consumer affect the consumer's behavior. One such technique, referred to as marketing mix modeling (MMM), applies multivariate regression to sales and marketing time series data to estimate how various marketing tactics influence sales. MMM attempts to define the effectiveness of a marketing tactic in terms of its contribution to sales volume and efficiency. However, because it is limited to a temporal analysis, MMM cannot provide causation inferences that are based on particular users, particular market segments, or particular marketing tactics that may have been applied simultaneously with other marketing tactics. MMM also tends to confuse correlation with causation.

Another analytical technique that has been applied in this regard is attribution modeling. In general, the process of allocating credit among marketer-consumer interactions for a particular outcome, such as for a purchase, is referred to as attribution. Attribution modeling can therefore be understood as the process of measuring, quantifying, and assigning credit to a plurality of interactions in a way that reflects the influence that each interaction has on a particular outcome. While attribution modeling represents an improvement over MMM in that it allows user- and channel-based inferences to be drawn, existing attribution modeling techniques still suffer from a number of shortcomings. Perhaps most significantly, many existing attribution models are based on arbitrary rules that, while simple to apply, ignore the nuances of a multichannel marketing campaign. For example, the last-touch attribution (LTA) model attributes an observed behavior to the marketer-consumer interaction—also referred to as a “touch”—that immediately preceded the observed behavior. Multi-touch attribution (MTA) models acknowledge that multiple interactions can each share a fraction of the credit for a particular outcome, but still tend to rely on arbitrary rules with respect to how to allocate such credit amongst the multiple interactions. Moreover, existing LTA and MTA models do not provide quantifiable outcomes, such as specific predictions with respect to order placement or revenue generation that can be attributed to individual marketing channels. The shortcomings associated with existing MMM and attribution modeling techniques therefore represent a substantial impediment to marketing analysts who seek to quantify the incremental effect of a marketing channel that forms part of a multichannel marketing campaign.

Thus, and in accordance with certain of the embodiments disclosed herein, techniques are disclosed for evaluating the incremental effect of a marketing channel that forms part of a multichannel marketing campaign. Such techniques could be used as part of a marketer's overarching strategy of optimizing resource allocation across a marketing campaign. For example, in one implementation data characterizing observed marketing interactions and outcomes is collected, wherein the marketing outcomes are expressed in terms of a binary conversion parameter. A conversion probability is estimated as a function of the observed interactions using logistic regression techniques, wherein converting and non-converting consumers comprise two classes upon which the regression is based. As a result, marketing interactions that are relatively more commonplace amongst converting consumers (as compared to non-converting consumers) receive greater attribution for observed conversions. It will be appreciated that any other suitable statistical model that estimates probability of a given outcome across different populations can be used in this regard. The estimated conversion probability is then used to predict an incremental quantity of conversions that can be attributed to a kth marketing channel based on the average treatment effect. Based on these predictions, it is possible to evaluate the extent to which market segment variables influence how attribution is distributed amongst various marketing channels. Numerous configurations and variations of this example implementation will be apparent in light of this disclosure.

A number of advantages are associated with one or more of the disclosed embodiments. For example, unlike MMM techniques and existing attribution modeling techniques, certain of the disclosed embodiments use an econometric model that is capable of estimating an incremental quantity of conversions that can be attributed to a given marketing channel. This model can be extended to estimate other desired outcomes, such as revenue generation, orders fulfilled, or votes won. As a result, such embodiments generate causal interpretations which are tied to measurable estimates in terms of metrics that are important to marketers, such as orders and revenue. This approach also captures interaction effects between multiple channels, which is particularly important where combining marketing tactics have a synergistic effect that produces results which are greater than the sum their individual contributions. In addition, certain of the disclosed embodiments improve upon existing attribution modeling techniques by eliminating biases that are inherent to the rule-based approach that such techniques rely upon. For example, LTA models tend to attribute excess importance to a “direct” marketing channel associated with consumers who directly navigate to a marketer's website. However, because the conversion rate is largely unaffected by whether or not a consumer directly navigates to the marketer's webpage, the econometric models disclosed herein attribute a lesser importance to the direct channel and instead attribute greater importance to interactions which may have preceded a direct navigation event.

As used herein, the term “data structure” refers broadly, in addition to its ordinary meaning, to a way of storing and organizing data in a computer accessible memory so that data can be used by an application or software module. A data structure in its simplest form can be, for example, a set of one or more memory locations. In some cases, a data structure may be implemented as a so-called record, sometimes referred to as a struct or tuple, and may have any appropriate number of fields, elements, or storage locations. As will be further appreciated, a data structure may include data of interest or a pointer that refers to a memory location where the data of interest can be found. A data structure may have any appropriate format such as, for example, a lookup table or index format; an array format; a hash table format; a graph, tree, or hierarchal format having a number of nodes; an object format that includes data fields, for instance similar to a record; or a combination of the foregoing. A data structure may include executable code for accessing and modifying the underlying structure and format of the data stored therein. In a more general sense, the data structure may be implemented as a data set that can store specific values without being constrained to any particular order or format. In one embodiment, a data structure comprises a table or graph correlating marketing channels with attribution parameters. In another embodiment a data structure comprises a table or graph correlating market segment identifiers with an importance quantifier that provides a measure of the extent to which attribution models differ for the identified market segment. Numerous other data structure formats and applications will be apparent in light of this disclosure.

As used herein, the terms “marketer” and “consumer” refer broadly, in addition to their ordinary meanings, to an originator and a recipient, respectively, of a marketing communication. Examples of marketers include a person or a company selling products and/or services; a government official encouraging citizens to volunteer for military service; and a politician stumping for votes. Corresponding examples of consumers include potential customers who are considering making a purchase from the person or company selling the product and/or service; a citizen considering enlisting in the armed forces; and a voter deciding how to cast a ballot. It will be appreciated that both marketers and consumers may refer to individual people, groups of people, or legal organizations. For example, in some cases the term marketer may refer generally to both a seller and a person or organization that the seller has designated to organize and manage a marketing campaign on the seller's behalf.

As used herein, the term “marketing channel” refers broadly, in addition to its ordinary meaning, to a way in which a marketer can interact and/or communicate with a consumer. Examples of conventional marketing channels include broadcast television advertising, direct mail solicitation, door-to-door campaigns, and display advertising. In the context of digital marketing, examples of marketing channels include search engine optimization, banner advertisements, electronic mail communications, and social networking. However, the term marketing channel encompasses not only the way in which a marketer interacts—or “touches”—a consumer, but also the marketer's communication as well. Thus, for example, while direct mail can be understood as a marketing channel in a general sense, a particular direct mail communication distributed to a particular demographic can also be understood as a marketing channel. Thus a marketing campaign that uses only direct mail solicitation, but that sends ten different communications to ten different target audiences can still be considered to be a multichannel marketing campaign. A marketing channel may also be referred to as a “consumer touch channel”.

As used herein, the term “conversion” refers broadly, in addition to its ordinary meaning, to achievement of a result that is considered to be the goal of a marketing campaign. For example, in the context of a sales campaign, conversion may refer to a desired endpoint such as executing a sale or receiving an order. Or, in the context of a military recruitment campaign, conversion may refer to enlistment of a new recruit. In general, conversion can be understood as referring to an observed event, the occurrence of which can be attributed to one or more marketing activities. A “conversion probability” can therefore be understood as representing the likelihood that a particular consumer will act in a particular way. In certain of the embodiments disclosed herein conversion probability can be used as the basis for estimating an incremental quantity of conversions that are attributed to a particular marketing channel.

System Architecture

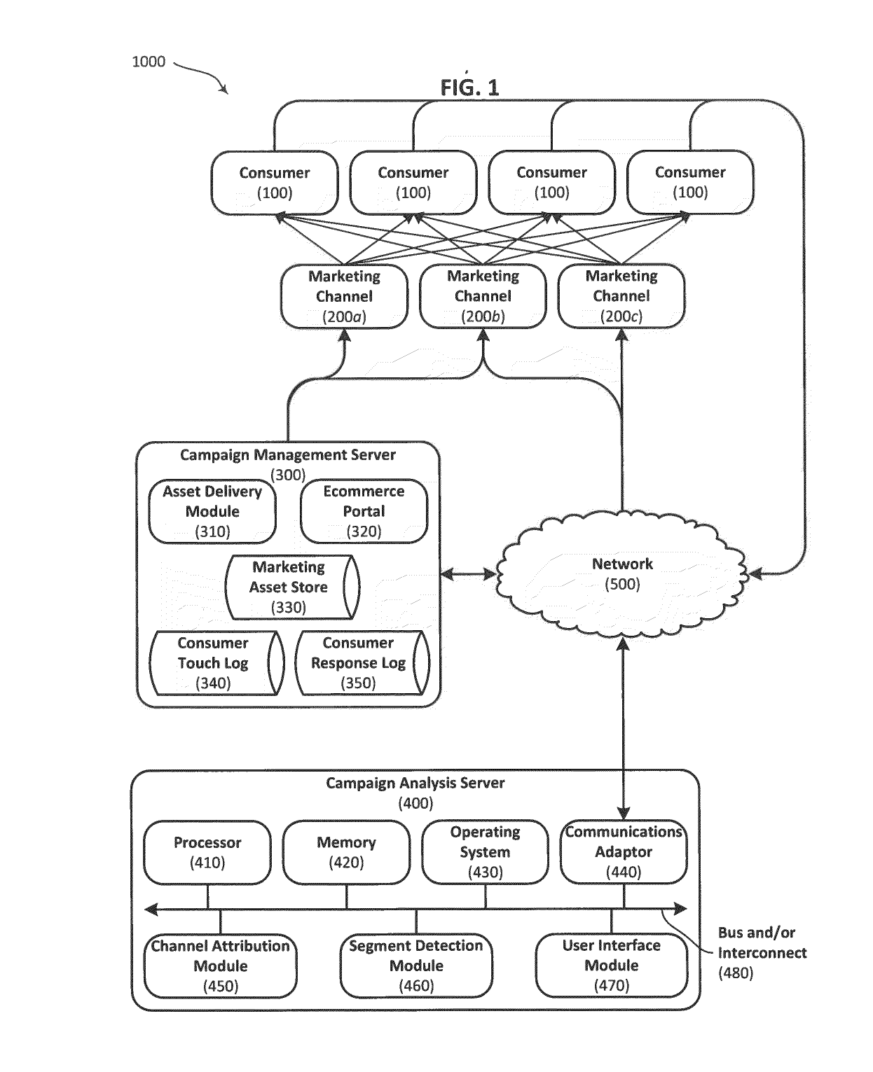

FIG. 1 is a block diagram schematically illustrating selected components of an example networked computer system 1000 that can be used to implement certain of the embodiments disclosed herein. For example, in one embodiment networked computer system 1000 is capable of evaluating the incremental effect of a marketing channel that forms part of a multichannel marketing campaign. Such embodiments can be understood as involving a series of interactions between a plurality of consumers 100, at least one campaign management server 300, and a campaign analysis server 400. These interactions may occur via a network 500, and in the case of interactions between consumers 100 and campaign management server 300, these interactions may additionally or alternatively occur via one or more marketing channels 200a, 200b, 200c. As illustrated, a given marketing channel can be used to interact with multiple consumers, just as a given consumer can receive communications via multiple marketing channels. The architecture and functionality of the various components and subcomponents comprising networked computer system 1000 will be described in turn. However, because the particular functionality provided in a given implementation may be specifically tailored to the demands of a particular application, this disclosure is not intended to be limited to provision or exclusion of any particular resources, components, or functionality.

In one embodiment campaign management server 300 comprises one or more enterprise class devices configured to provide a range of services that may be invoked in the management of one or more marketing campaigns. Examples of such services include the capacity to host marketing assets, respond to requests to deliver the hosted assets to consumers 100 via designated marketing channels 200a, 200b, 200c, and provide ecommerce services to consumers 100. For example, in one implementation campaign management server 300 includes an asset delivery module 310 that is capable of managing the delivery of marketing assets to consumers 100 via marketing channels 200a, 200b, 200c. The marketing assets may be retained in a marketing asset store 330 that is local to campaign management server 300, may be retained in one or more networked storage repositories, or may be retained using a combination of local and remote storage resources. Although one campaign management server is illustrated in FIG. 1, it will be appreciated that, in general, tens, hundreds, thousands, or more campaign management servers can be used to manage an even larger number of marketing campaigns.

Still referring to FIG. 1, in certain embodiments campaign management server 300 includes a consumer touch log 340 that is configured to maintain a data structure that indexes marketer-consumer interactions, also referred to as “touch points” or “touches”. For example, in one embodiment consumer touch log 340 is configured to work in conjunction with asset delivery module 310 to record touch points, and in particular, to record the date and time at which a particular marketing asset is delivered to a particular consumer via a particular marketing channel. Consumer touch log 340 can also be configured to record the extent to which the consumer interacts with the received asset, for example by recording whether a consumer clicks on a hyperlink provided in an electronic mail communication or banner advertisement. User profile data for the receiving consumer is optionally collected as well. While consumer touch log 340 can be configured to work in conjunction with asset delivery module 310, in other embodiments consumer touch log 340 is additionally or alternatively configured to maintain a record of marketer-consumer interactions that are unrelated to events associated with asset delivery module 310 or even campaign management server 300. For example, in one embodiment consumer touch log 340 is configured to maintain a record of whether a particular consumer has previously made a purchase from a particular marketer, contacted the marketer via telephone, or visited the marketer's website. In general, it will be appreciated that consumer touch log 340 can use a wide range of existing and subsequently-developed data tracking and monitoring techniques to collect information from diverse data sources that characterize the interactions that occur between marketers and consumers.

In embodiments wherein the goal of the marketing campaign is to motivate consumers 100 to complete a financial transaction, such as by making a purchase, campaign management server 300 is optionally configured to provide ecommerce services to consumers 100 via an ecommerce portal 320. In such embodiments, one or more of the marketing assets distributed to consumers 100 may include a hyperlink that enables consumers 100 to easily access the services provided by ecommerce portal 320. In alternative embodiments wherein the goal of the marketing campaign is to motivate consumers to take action that is not directly related to a financial transaction, such as enlisting in the armed forces, volunteering time for a charitable cause, or voting for a political candidate, ecommerce portal 320 can be replaced with an appropriate consumer interaction portal that helps consumers compete the desired action. It will be appreciated that in alternative embodiments the services provided by ecommerce portal 320 can instead be provided by a separate networked ecommerce server or consumer interaction server that is distinct from campaign management server 300.

Regardless of the context in which it is implemented, ecommerce portal 320 (or an alternate consumer interaction portal) can be configured to operate in conjunction with a consumer response log 350 that maintains a data structure that indexes results of the observed marketer-consumer interactions. For example, in one embodiment consumer response log 350 is configured to work in conjunction with ecommerce portal 320 to record consumer purchase events. In such case, purchase events are recorded regardless of whether the purchasing consumer interacted with the marketer before the purchase event. Consumer response log 350 can also be configured to record other parameters that further characterize the consumer response, such as revenue generated as the result of a purchase, date and time of a purchase, and user profile information. In particular, recording the date and time of a purchase allows the purchase point to be compared to dates and times at which the purchasing consumer may have received marketing communications. In embodiments implemented using one or more remotely-located ecommerce portals, consumer response log 350 can be configured to index marketing outcomes from such multiple portals 320. Likewise, in alternative embodiments wherein the goal of the marketing campaign is to motivate consumers to take action that is not directly related to a financial transaction, consumer response log 350 can be configured to record data characterizing the consumer response, such as whether the consumer decided to serve as a volunteer for a charitable cause or who the consumer voted for in an election. In general, it will be appreciated that consumer response log 350 can use a wide range of existing and subsequently-developed data tracking and monitoring techniques to collect information from diverse sources that characterize consumer behavior.

Referring again to the example embodiment illustrated in FIG. 1, in certain implementations campaign analysis server 400 comprises one or more computing devices that are configured to provide a range of analytical services that may be used to evaluate the incremental effect of a marketing channel that forms part of a multichannel marketing campaign. Campaign analysis server 400 may comprise, for example, one or more devices selected from a desktop computer, a laptop computer, a workstation, a tablet computer, a smartphone, a handheld computer, a set-top box, an enterprise class server, or any other suitable computing device. A combination of different devices may be used in certain embodiments. In the illustrated embodiment, campaign analysis server 400 includes one or more software modules configured to implement certain of the functionalities disclosed herein, as well as hardware configured to enable such implementation. These hardware and software components may include, among other things, a processor 410, a memory 420, an operating system 430, and a communications adaptor 440. A bus and/or interconnect 480 is also provided to allow for inter- and intra-device communications using, for example, communications adaptor 440 and/or network 500.

Processor 410 can be implemented using any suitable processor, and may include one or more coprocessors or controllers, such as an audio processor or a graphics processing unit, to assist in processing operations of campaign analysis server 400. Likewise, memory 420 can be implemented using any suitable type of digital storage, such as one or more of a disk drive, a universal serial bus (USB) drive, flash memory, random access memory (RAM), or any suitable combination of the foregoing. Memory 420 can be used, for example, to store analytical results generated by campaign analysis server 400. Memory 420 can also be used, for example to store data hosted by marketing asset store 330, consumer touch log 340, and/or consumer response log 350. Operating system 430 may comprise any suitable operating system, such as Google Android (Google Inc., Mountain View, Calif.), Microsoft Windows (Microsoft Corp., Redmond, Wash.), or Apple OS X (Apple Inc., Cupertino, Calif.). As will be appreciated in light of this disclosure, the techniques provided herein can be implemented without regard to the particular operating system provided in conjunction with campaign analysis server 400, and therefore may also be implemented using any suitable existing or subsequently-developed platform. Communications adaptor 440 can be implemented using any appropriate network chip or chipset which allows for wired or wireless connection to network 500 and/or other computing devices and/or resources.

Campaign analysis server 400 is coupled to network 500 to allow for communications with other computing devices and resources, such as campaign management server 300. Network 500 may be a local area network (such as a home-based or office network), a wide area network (such as the Internet), or a combination of such networks, whether public, private, or both. In some cases access to resources on a given network or computing system may require credentials such as usernames, passwords, or any other suitable security mechanism. In general, other componentry and functionality not reflected in the schematic block diagram of FIG. 1 will be readily apparent in light of this disclosure, and it will be appreciated that the claimed invention is not intended to be limited to any specific hardware configuration. Thus other configurations and subcomponents can be used in other embodiments.

Still referring to the example embodiment illustrated in FIG. 1, campaign analysis server 400 includes software modules such as a channel attribution module 450, a segment detection module 460, and a user interface module 470. In such embodiments, channel attribution module 450 is configured to estimate conversion probability based on an observed collection of marketer-consumer interactions, such as may be recorded in consumer touch log 340. The estimated conversion probabilities can be used to predict an incremental quantity of conversions that can be attributed to a particular marketing channel. Channel attribution module 450 can also be configured to estimate revenue generation based on the observed collection of marketer-consumer interactions. Segment detection module 460 is configured to evaluate the extent to which market segment variables influence how attribution is distributed amongst various marketing channels. Additional details regarding the functionality provided by channel attribution module 450 and segment detection module 460 will be provided in turn. User interface module 470 can be configured to receive user queries and generate numerical and graphical representations of, for example, how conversions are attributed to a plurality of marketing channels, or how different market segments defined by a market variable adhere to different attribution models.

The embodiments disclosed herein can be implemented in various forms of hardware, software, firmware, or special purpose processors. For example, in one embodiment a non-transitory computer readable medium has instructions encoded thereon that, when executed by one or more processors, cause one or more of the marketing research methodologies disclosed herein to be implemented. The instructions can be encoded using one or more suitable programming languages, such as C, C++, object-oriented C, JavaScript, Visual Basic .NET, BASIC, or alternatively, using custom or proprietary instruction sets. Such instructions can be provided in the form of one or more computer software applications or applets that are tangibly embodied on a memory device, and that can be executed by a computer having any suitable architecture. In one embodiment the system can be hosted on a given website and implemented using JavaScript or another suitable browser-based technology.

The functionalities disclosed herein can optionally be incorporated into a variety of different software applications, such as campaign management applications, or can optionally leverage services provided by other software applications, such as statistical analysis and modeling applications. The computer software applications disclosed herein may include a number of different modules, sub-modules, or other components of distinct functionality, and can provide information to, or receive information from, still other components and/or services. These modules can be used, for example, to communicate with input and/or output devices such as a display screen, a touch sensitive surface, a printer, and/or any other suitable input/output device. Other components and functionality not reflected in the illustrations will be apparent in light of this disclosure, and it will be appreciated that the claimed invention is not intended to be limited to any particular hardware or software configuration. Thus in other embodiments the various components of networked computer system may comprise additional, fewer, or alternative subcomponents as compared to those included in the example embodiment illustrated in FIG. 1.

The aforementioned non-transitory computer readable medium may be any suitable medium for storing digital information, such as a hard drive, a server, a flash memory, and/or RAM. In alternative embodiments, the components and/or modules disclosed herein can be implemented with hardware, including gate level logic such as a field-programmable gate array (FPGA), or alternatively, a purpose-built semiconductor such as an application-specific integrated circuit (ASIC). Still other embodiments may be implemented with a microcontroller having a number of input/output ports for receiving and outputting data, and a number of embedded routines for carrying out the various functionalities disclosed herein. It will be apparent that any suitable combination of hardware, software, and firmware can be used in this regard, and that the present invention is not intended to be limited to any particular system architecture.

Methodology and Results

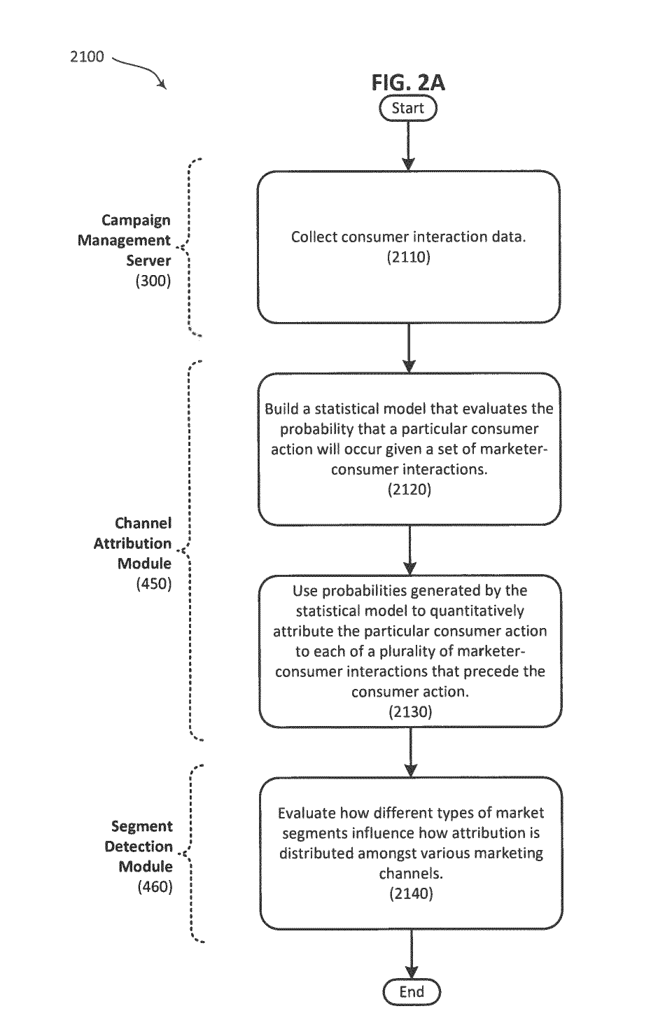

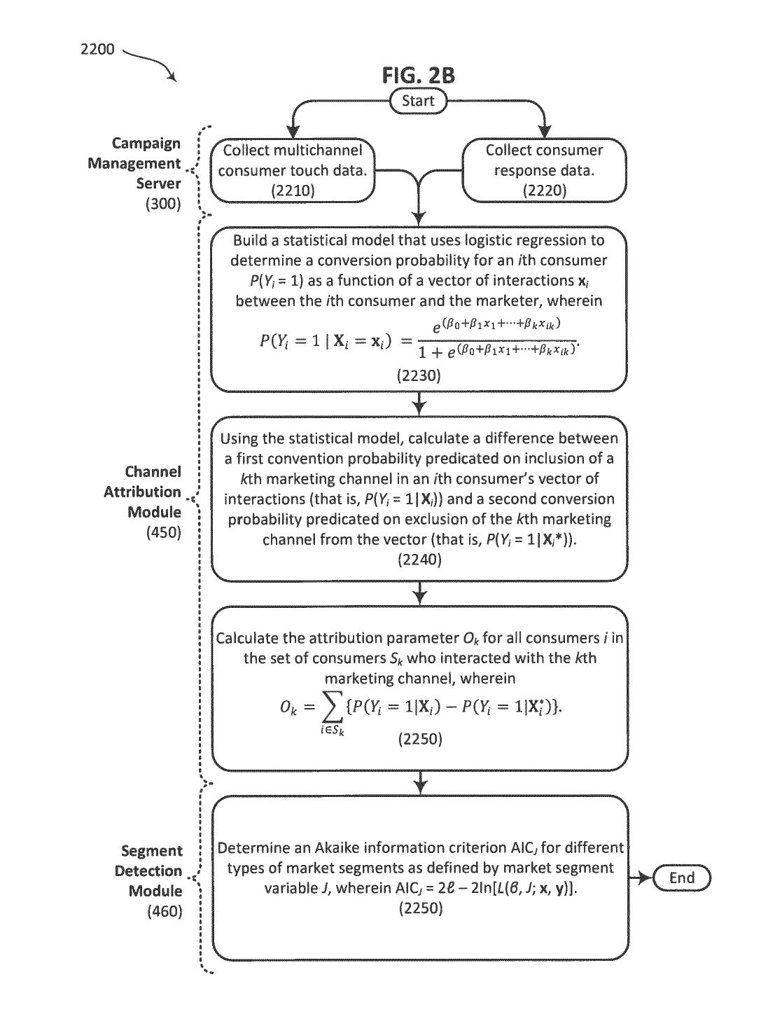

FIGS. 2A and 2B are flowcharts illustrating example methods for evaluating the incremental effect of a marketing channel that forms part of a multichannel marketing campaign. These methodologies each include a number of phases and sub-processes, the sequence of which may vary form one embodiment to another. However, when considered in the aggregate, these phases and sub-processes form complete processes for modeling marketing channel attribution that is responsive to user commands in accordance with certain of the embodiments disclosed herein. These methodologies can be implemented, for example, using the system architecture illustrated in FIG. 1 and described herein. However other system architectures can be used in other embodiments, as will be apparent in light of this disclosure. To this end, the correlation of the various functions shown in FIGS. 2A and 2B to the specific components illustrated in FIG. 1 is not intended to imply any structural and/or use limitations. Rather, other embodiments may include, for example, varying degrees of integration wherein multiple functionalities are effectively performed by one system. For example in an alternative embodiment a single module can be used to perform both channel attribution and segment detection. Or, in another alternative embodiment, the services provided by ecommerce portal 320 can be provided by a separate server that is distinct from campaign management server 300. Thus other embodiments may have fewer or more modules depending on the granularity of implementation. Numerous variations and alternative configurations will be apparent in light of this disclosure.

As illustrated in FIG. 2A, a first example method 2100 commences with campaign management server 300 collecting consumer interaction data that characterizes observed marketer-consumer interactions and outcomes. See reference numeral 2110 in FIG. 2A. Based on this observed data, a statistical model is built, wherein the statistical model evaluates the probability that a particular consumer action will occur given a set of marketer-consumer interactions. See reference numeral 2120 in FIG. 2A. The probabilities generated by the statistical model can be used to quantitatively attribute the particular consumer action to each of a plurality of marketer-consumer interactions that precede the consumer action. See reference numeral 2130 in FIG. 2A. This attribution modeling is thus based on data generated by a statistical model that attributes greater significant to marketing interactions that are observed with greater frequency amongst consumers taken the particular action. As such, the evaluation provided using this technique may be referred to as a “data driven” attribution model, which distinguishes, for example, an LTA model which is based on an arbitrary allocation rule that is uniformly applied without regard to the observed data. Data driven attribution models tend to provide more accurate attribution estimates as compared to attribution models that rely on arbitrary rules. Once attribution has been quantified across a range of market segments, it is possible to evaluate how different types of market segments influence how attribution is distributed amongst various marketing channels. See reference numeral 2140 in FIG. 2A.

As illustrated in FIG. 2B, a second example method 2200 commences with campaign management server 300 collecting multichannel consumer touch data. See reference numeral 2210 in FIG. 2B. For example, in one specific implementation consumer touch log 340 is configured to work in conjunction with asset delivery module 310 to record touch points, and in particular, to track the date and time at which marketer-consumer interactions are communicated, as well as the marketing channels through which such interactions occur. Consumer touch log 340 can be configured to aggregate touch data from a wide range of data sources that collectively provide information on tens, hundreds, thousands, millions, or more marketer-consumer interactions. Method 2000 may also commence with campaign management server 300 collecting consumer response data. See reference numeral 2220 in FIG. 2B. For example, in one specific implementation consumer response log 250 is configured to work in conjunction with ecommerce portal 320 to record consumer purchase events, and in particular, to track the date and time at which conversions occur. In ecommerce applications, revenue derived from the recorded conversions can be tracked as well. Consumer response log 350 can be configured to aggregate response data from a wide range of data sources that collectively provide information on tens, hundred, thousands, millions, or more marketing conversions. The consumer touch and response data can be collected sequentially or concurrently, and once collected, can be provided to campaign analysis server 400 for subsequent processing.

Once consumer touch and response data is gathered and provided to campaign analysis server 400, channel attribution module 450 can be configured to build a statistical model that is capable of determining conversion probabilities based on the received data. For example, in one embodiment conversion probability is estimated as a function of the observed interactions using logistic regression techniques, wherein converting and non-converting consumers comprise two distinct classes upon which the regression is based. Other statistical models that are capable of estimating the probability of a given outcome across different populations can also be used in this regard, including the random forests ensemble learning method (which advantageously captures interaction effects) and the Cox proportional hazards model (which advantageously maintains awareness of the time sequence of the observed interactions). In general, P(Yᵢ=1|Xᵢ=xᵢ) can be understood a representing the probability that an event Yᵢ involving an ith consumer results in a conversion given a vector of interactions Xᵢ=xᵢ that is experienced by the ith consumer. For example, the vector Xᵢ may include both the number and type of interactions experienced by the ith individual, as well as the date and time of each observed interaction. Where logistic regression is applied to determine this probability,

$$P ( {Y}_{i} = 1 \vert {X}_{i} = {x}_{i} ) = \frac{{e}^{( {β}_{0} + {β}_{1} {x}_{1} + … + {β}_{k} {x}_{ik} )}}{1 + {e}^{( {β}_{0} + {β}_{1} {x}_{1} + … + {β}_{k} {x}_{ik} )}} , \qquad ( 1 )$$

where β₀, β₁, . . . βₖ are regression coefficients indicating the relative effect of the kth marketing channel. In alternative embodiments the extent to which a marketing tactic influences consumer behavior over time can be modeled by incorporating survival models and/or decay parameters into the logistic regression techniques disclosed herein. Thus in certain embodiments method 2200 further comprises building a statistical model that uses logistic regression to determine a conversion probability for an ith consumer as a function of a vector of interactions between the ith consumer and a marketer using Equation (1). See reference numeral 2230 in FIG. 2B.

Once the conversion probabilities have been modeled, the resulting probability models can then be used to define an attribution model that predicts the extent to which a consumer's response can be attributed to an observed marketing channel, as quantified by an attribution parameter. This can be accomplished by recognizing that even if a particular marketing channel were terminated, conversions will still occur, even if at a reduced frequency. This incremental effect of terminating a kth marketing channel can therefore be quantified as

δₖ=Nₖ−N*ₖ (2)

where Nₖ represents the number of consumers who converted after interacting with channel k, and N*ₖ represents the number of consumers who would have converted even without interacting with channel k. Since N*ₖ cannot be measured directly, statistical models can be used to provide an estimate. In particular, if Oₖ represents the number of conversions that can be attributed to the kth marketing channel, and Sₖ denotes the set of consumers who interacted with the kth channel, then

$${O}_{k} = {\sum }_{i ∈ {S}_{k}} \{ P ( {Y}_{i} = 1 \vert {X}_{i} ) - P ( {Y}_{i} = 1 \vert {X}_{i}^{*} ) \} . \qquad ( 3 )$$

The vector X*ᵢ denotes the vector Xᵢ with the kth channel reduced to zero. Thus in certain embodiments method 2200 further comprises using the statistical model defined by Equation (1) to calculate a difference between a first conversion probability predicated on inclusion of the kth marketing channel in the ith consumer's vector of interactions (that is, P(Yᵢ=1|Xᵢ)) and a second conversion probability predicated on exclusion of the kth marketing channel from the vector (that is, P(Yᵢ=1|Xᵢ). See reference numeral 2240 in FIG. 2B. The attribution parameter Oₖ representing the number of conversions that can be attributed to the kth marketing channel can then be calculated by summing the differences P(Yᵢ=1|Xᵢ)−P(Yᵢ=1|X*ᵢ) for all consumers i in the set of consumers Sₖ who interacted with the kth marketing channel, as indicated by Equation (3). See reference numeral 2250 in FIG. 2B.

In the ecommerce context, wherein a conversion correlates to a purchase, the revenue Rₖ attributed to the kth channel can be computed as

$${R}_{k} = {\sum }_{i ∈ {S}_{k}} \{ P ( {Y}_{i} = 1 \vert {X}_{i} ) - P ( {Y}_{i} = 1 \vert {X}_{i}^{*} ) \} \times {r}_{i} , \qquad ( 4 )$$

where rᵢ is the revenue resulting from the ith consumer's conversion, if any. Thus the attribution parameter Rₖ is based on a difference between a first conversion probability predicated on inclusion of the kth marketing channel in the ith consumer's vector of interactions (that is, P(Yᵢ=1|Xᵢ) and a second conversion probability predicated on exclusion of the kth marketing channel from the vector (that is, P(Yᵢ=1|Xᵢ). Equations (3) and (4) can be understood as representing the average treatment effect, additional details of which are disclosed in Wooldridge, Introductory Econometrics: A Modern Approach, Cengage Learning, 5th Ed., Section 13.2, pp. 454-459 (2013). The attribution parameters Oₖ and Rₖ are optionally normalized such that conversion or revenue attribution can be expressed as a percentage.

Equations (3) and (4) can be used to evaluate the incremental effect, respectively in terms of conversion and revenue, of a marketing channel that forms part of a multichannel marketing campaign. These equations are based on an algorithmically developed probability model that attributes greater significance to marketing interactions that are observed with greater frequency amongst converting consumers (as compared to non-converting consumers). As such, the evaluation provided using this technique may be referred to as a “data driven” attribution model, which distinguishes, for example, an LTA model which is based on an arbitrary allocation rule that is uniformly applied without regard to the observed data. As a result of this distinction, data driven attribution models tend to provide more accurate attribution estimates.

The conversion and revenue attribution models represented by Equations (3) and (4) can be applied to consumer touch and response data collected during a multichannel marketing campaign, thereby resulting in conversion and revenue attribution parameters for each of the channels comprising the campaign. For example, in one implementation a multichannel marketing campaign directed at over 26 million unique consumers in the travel and entertainment experience industry was analyzed. Using Adobe® Analytics (Adobe Systems Incorporated, San Jose, Calif.), approximately 3.6 terabytes of data was collected corresponding to about 2 billion page views. This raw data was subjected to an optional stratification process to reduce subsequent processing times. The stratification, which was based on a time window selected from the overall data collection period, resulted in a smaller training dataset comprising a row for each marketer-consumer interaction, wherein a unique visitor identifier, a date and time, an interaction type, a binary (yes/no) conversion parameter, and a revenue value (if any) were recorded for each interaction. This training dataset consisted of approximately five million rows. Order and revenue attribution was evaluated for each of the following nine marketing channels which formed part of the overall marketing campaign: display advertising (“display_ad”), social media (“social_media”), email advertising (“email”), referrals from websites not affiliated with the marketer (“other_websites”), search engine advertising (“search_ad”), referrals form travel agents (“travelagents”), referrals from websites affiliated with the marketer (“other_owned”), direct navigation to the marketer's website (“direct”), and organic search engine referrals (“search”).

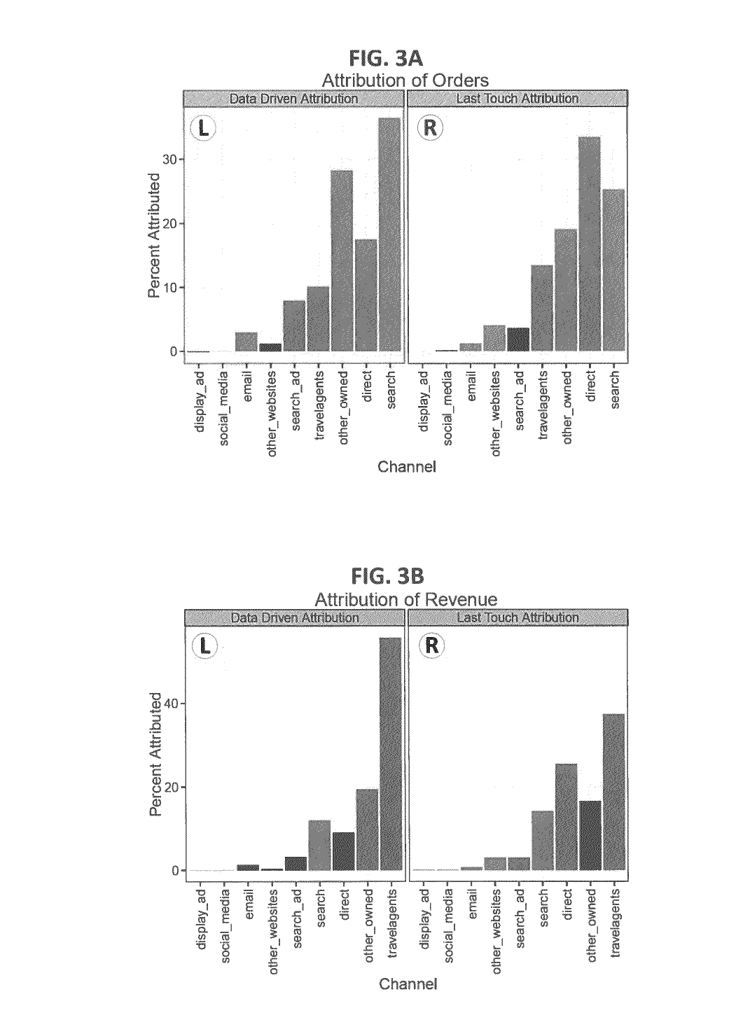

FIG. 3A consists of two bar charts illustrating order attribution parameters for these nine marketing channels. These bar charts can be configured and generated using user interface module 470. The attribution data provided in the bar chart on the left side of FIG. 3A (“L”) was derived using the data driven attribution model as provided by Equation (3), while the attribution data provided in the bar chart on the right side of FIG. 3A (“R”) was derived using an existing LTA model. As can be seen, the LTA model attributes great significance to the direct navigation channel. A consumer may spend days or weeks researching a purchase, only to navigate directly to the marketer's website once a purchase decision has been made. However, once all interactions are considered, such as by using the data driven attribution models disclosed herein, it becomes clear that direct navigation is actually entitled to a significantly smaller attribution share, while search and referrals from the marketer's affiliated websites are entitled to significantly larger attribution shares. FIG. 3A also illustrates that search engine advertising and email advertising are actually entitled to an attribution share that is two or three times larger than would otherwise be apparent using an LTA model.

Likewise, FIG. 3B consists of two bar charts illustrating revenue attribution parameters for the same nine marketing channels. These bar charts can also be configured and generated using user interface module 470. The attribution data provided in the bar chart on the left side of FIG. 3B (“L”) was derived using the data driven attribution model as provided by Equation (4), while the attribution data provided in the bar chart on the right side of FIG. 3B (“R”) was derived using an existing LTA model. In this case, the data driven attribution model reveals that travel agents contribute to more than half of the generated revenue, which is a significantly greater share than indicated by the LTA model. Therefore, based on an analysis that considers all of the marketer-consumer interactions, it can be inferred that consumers who arrive based on a travel agent's referral are inclined to make much larger purchases. This inference is lost in the LTA model.

Referring again to FIG. 2B, in certain embodiments segment detection module 460 is configured to evaluate how different types of market segments influence how attribution is distributed amongst various marketing channels. In particular, the data driven attribution modeling techniques disclosed herein provide insight into the incremental effect of a particular marketing channel. However, a natural next question is to systematically identify market segment variables that define market segments which strongly influence how attribution is distributed amongst the analyzed marketing channels. For example, it may be that consumers in different geographical regions respond dramatically differently to different marketing channels, thus leading a marketer to devote resources to creating marketing campaigns which are customized to particular geographical regions. On the other hand, if users of different mobile operating systems all respond similarly to different marketing channels, then a marketer may decide to avoid devoting resources to creating marketing campaigns which are customized to users of Android, iOS, or other specific mobile operating systems. This evaluation of how different types of market segments influence how attribution is distributed amongst various marketing channels is referred to as “segment detection” since it results in detection of market segments that respond particularly well (or poorly) to different types of marketer-consumer interactions. Certain of the techniques disclosed herein provide segment detection in a way that is automated and statistically robust, thus helping marketers to allocate marketing resources more efficiently.

To perform segment detection, a more general version of Equation (1) is invoked, wherein xᵢⱼₖ is the number of interactions of the ith individual, who is a member of the jth market segment, with the kth marketing channel. In this case, the likelihood L(β; x, y) that all members of the market segment respond in the same way to the xᵢⱼₖth interaction is given by

$$L ( β ; x , y ) = {\prod }_{i} {{exp ( {\sum }_{k} {β}_{k} {x}_{ijk} )}^{{y}_{i}} [ 1 + exp ( {\sum }_{k} {β}_{k} {x}_{ijk} ) ]}^{1 - {y}_{i}} , \qquad ( 5 )$$

where the outcome vector y includes a yᵢth result. If the likelihood L(β; x, y) is to be calculated using different intercept and slope terms in the logistic regression for each market segment j, where J is a variable defining market segment j, the likelihood is given by

$$L ( β , J ; x , y ) = {\prod }_{i} {{exp ( {\sum }_{k} {β}_{kj} {x}_{ijk} )}^{{y}_{i}} [ 1 + exp ( {\sum }_{k , j} {β}_{kj} {x}_{ijk} ) ]}^{1 - {y}_{i}} . \qquad ( 6 )$$

The market segment variable J can be used to define a particular market segment j. For example, the market segment variable “country” (J) defines a particular market segment “users from Latin America” (j), among others. The market segment variables can be ordered based on the Akaike information criterion (AIC) for each variable, which is defined as

AICⱼ=2l−2 ln [L(β,J;x,y)], (7)

where l is the number of parameters that are estimated in Equation (6). See reference numeral 2250 in FIG. 2B. The market segment variable with the smallest AIC_{J} may be understood as defining market segments which strongly influence how attribution is distributed amongst the analyzed marketing channels. Additional information on the AIC is provided in Akaike, “A New Look at the Statistical Model Identification”, IEEE Transactions on Automatic Control, Vol. AC-19, No. 6 (December 1974).

The AIC parameter provided by Equation (7) can be calculated based on consumer touch and response data collected during a multichannel marketing campaign. This results in an indication of which types of marketing segments respond particularly well (or poorly) to different marketing channels. For example, in one embodiment the aforementioned multichannel marketing campaign data which was used as the basis for the attribution data illustrated in FIGS. 3A and 3B is also used to perform segment detection as described herein. More specifically, in this particular embodiment a derived data subset comprising a row for each consumer is generated, wherein a binary (yes/no) conversion parameter, an interaction quantity for each analyzed marketing channel, and a revenue value (if any) are recorded for each consumer. Market segment variables defining one or more market segments to which the consumer belongs, such as mobile operating system type (“mobileos”), non-mobile operating system type (“ostype”), device type (“devicetype”), cookie age (“cookieagedays”), first visit referrer (“firstvisitref”), visit frequency (“frequencydays”), geographical location (“region”), and cookie content (“cookies”) are optionally recorded as well. Such data can be applied to Equation (7) to evaluate AIC for each of the plurality of market segment variables J.

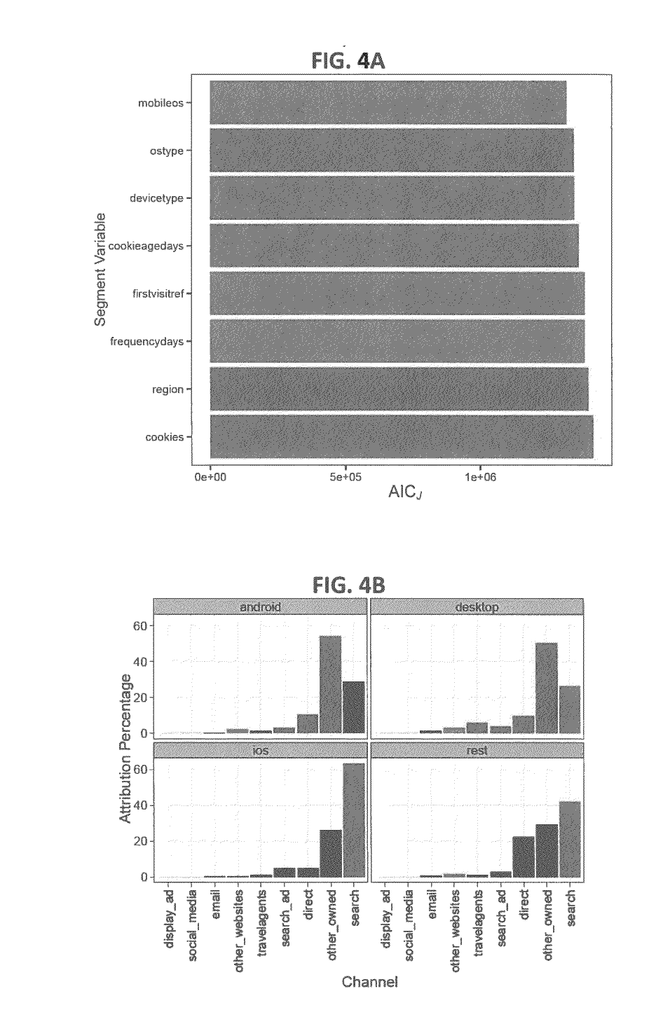

FIG. 4A is a bar chart illustrating the extent to which various market segment variables influence how attribution is distributed amongst marketing channels defined by such variables, wherein such influence is measured by AIC_{J}. In particular, FIG. 4A illustrates that the market segment variables geographical location (“region”) and cookie content (“cookies”) have relatively high AIC_{J} values, indicating that market segments defined by these variables respond to the analyzed marketing channels relatively uniformly. On the other hand, the market segment variables mobile operating system type (“mobileos”), and non-mobile operating system type (“ostype”) have relatively low AIC values, indicating that market segments defined by these variables respond to the analyzed marketing channels in significantly different ways. In view of this data, a marketer might choose to generate customized marketing campaigns for users of different mobile operating systems as compared to users in different geographical regions.

For example, FIG. 4B consists of four bar charts illustrating order attribution for the same nine marketing channels analyzed in FIGS. 3A and 3B. In particular, the attribution data illustrated in FIG. 4B was derived by applying the data driven attribution model disclosed herein to the multichannel marketing campaign data that was also used to generate the attribution results illustrated in FIGS. 3A and 3B. Each of the four bar charts illustrates attribution data for a different market segment that is defined by the market segment variable “mobileos”. For example, the attribution data provided in the top left bar chart (“android”) was generated using only data associated with consumers using an Android mobile operating system, the attribution data provided in the top right bar chart (“desktop”) was generated using only data associated with consumers using a desktop operating system, the attribution data provided in the bottom left bar chart (“ios”) was generated using only data associated with consumers using an iOS mobile operating system, and the attribution data provided in the bottom right bar chart (“rest”) was generated using data associated with consumers using other operating systems. The bar charts illustrated in FIGS. 4A and 4B can be configured and generated using user interface module 470.

As would be expected from the relatively low AIC_{J} value for the marketing variable “mobileos”, FIG. 4B evinces significant differences in the way certain market segments defined by marketing variable “mobileos” respond to certain marketing channels. For example, consumers using iOS mobile operating systems respond strongly to organic search results (“search”), but tend not to navigate via referrals from websites affiliated with the marketer (“other_owned”). On the other hand, consumers using Android mobile operating systems do not respond strongly to organic search results, but do tend to navigate via referrals from websites affiliated with the marketer. These results suggest that the marketer would be well-advised to devote resources to generating marketing campaigns that are specifically tailored to consumers using different mobile operating systems, since, for example, a campaign that relies heavily on search engine optimization (SEO) techniques will likely be much more effective for consumers using iOS mobile operating systems, since these customers respond strongly to organic search than users of Android mobile operating systems. This illustrates how automatic segment detection techniques enable marketers to quickly and reliably identify fields in which tailoring a marketing campaign to a specific market segment is likely to yield significant benefits.

### CONCLUSION

Numerous variations and configurations will be apparent in light of this disclosure. For instance, one example embodiment provides a method for evaluating the incremental effect of a marketing channel. The method comprises receiving consumer touch data that characterizes interactions between at least one marketer and a plurality of consumers. Each of the interactions is associated with at least one of a plurality of marketing channels. The method further comprises receiving consumer response data that characterizes an outcome of each of the interactions in terms of a conversion parameter. The method further comprises generating a statistical model that is configured to determine a conversion probability as a function of a vector of a subset of the interactions. The statistical model is based on the consumer touch data and the consumer response data. The method further comprises, for a particular one of the plurality of marketing channels, determining an attribution parameter based on a first conversion probability predicated on inclusion of the particular marketing channel in the vector and a second conversion probability predicated on exclusion of the particular marketing channel from the vector. The first and second conversion probabilities are calculated based on the statistical model. In some cases the consumer touch data and the consumer response data are received from a campaign management server configured to deliver marketing assets to the plurality of consumers via the plurality of marketing channels. In some cases the consumer touch data and the consumer response data are received concurrently. In some cases (a) the outcome of each of the interactions is further characterized by a revenue value; and (b) the statistical model is further configured to determine an expected revenue as a function of the vector. In some cases (a) the conversion parameter is a binary parameter that indicates whether a particular consumer placed an order; and (b) the outcome of each of the interactions is further characterized by a revenue value. In some cases the statistical model is selected from a group consisting of logistic regression, random forests ensemble learning, and Cox proportional hazards model. In some cases (a) the attribution parameter is expressed in terms of an attribution percentage; and (b) the attribution parameter is determined for each one of the plurality of marketing channels. In some cases the method further comprises (a) determining the attribution parameter for each of the plurality of marketing channels; and (b) generating a bar chart illustrating the attribution parameters for each of the plurality of marketing channels. In some cases (a) the outcome of each of the interactions is further characterized by a revenue value; (b) the statistical model is further configured to determine an expected revenue as a function of the vector of a subset of the interactions; and (c) the method further comprises, for a particular one of the plurality of marketing channels, determining a revenue attribution parameter based on a difference between a first expected revenue predicated on inclusion of the particular marketing channel in the vector and a second expected revenue predicated on exclusion of the particular marketing channel from the vector, wherein the first and second expected revenues are calculated based on the statistical model. In some cases (a) each of the consumers belongs to at least one of a plurality of market segments; (b) the plurality of market segments are collectively defined by a market segment variable; (c) a collection of attribution parameters are determined for each of the market segments; and (d) the method further comprises determining a Akaike information criterion coefficient that correlates the market segment variable with an extent to which the collection of attribution parameters varies for the different market segments defined by the market segment variable.

Another example embodiment of the present invention provides a system for attributing consumer behavior to a marketing channel. The system comprises a channel attribution module. The channel attribution module is configured to generate a statistical model that is configured to determine a conversion probability as a function of a vector of marketer-consumer interactions, wherein the vector is associated with a plurality of marketing channels through which the interactions are communicated. The channel attribution module is further configured to determine a plurality of attribution parameters, each of which is based on a difference between a first conversion probability predicated on inclusion of a particular marketing channel in the vector and a second conversion probability predicated on exclusion of the particular marketing channel from the vector. The system further comprises a segment detection module configured to determine a coefficient that correlates a market segment variable with fluctuations in the determined attribution parameters amongst market segments that are defined by the market segment variable. In some cases the statistical model is further configured to determine an expected revenue as a function of the vector of marketer-consumer interactions. In some cases the channel attribution module and the segment detection module form part of a campaign analysis server that is configured to receive consumer touch data that characterizes the marketer-consumer interactions. In some cases the system further comprises a user interface module configured to generate a bar chart illustrating the coefficient for a plurality of marketing segment variables. In some cases the system further comprises a user interface module configured to receive a user query that identifies a plurality of marketing segment variables for which the coefficients are to be determined. In some cases the coefficient is an Akaike information criterion coefficient.

Another example embodiment of the present invention provides a computer program product encoded with instructions that, when executed by one or more processors, cause a segment detection process to be carried out. The process comprises receiving consumer touch data that characterizes interactions between a marketer and a plurality of consumers. Each of the interactions is associated with at least one of a plurality of marketing channels. Each of the consumers belongs to at least one of a plurality of market segments. The plurality of market segments are collectively defined by a market segment variable. The process further comprises receiving consumer response data that characterizes an outcome associated with each of the interactions in terms of a conversion parameter. The process further comprises, for each of the market segments, determining a collection of attribution parameters. Each of the attribution parameters represents an extent to which the outcome is attributed to each of the marketing channels. The process further comprises determining a coefficient that correlates the market segment variable with an extent to which the collection of attribution parameters varies for the market segments defined by the market segment variable. In some cases (a) the consumer response data further characterizes the outcome associated with each of the interactions in terms of revenue generated; and (b) for each of the market segments, determining a second collection of attribution parameters, wherein each of the attribution parameters in the second collection represents an extent to which the revenue generated is attributed to each of the marketing channels. In some cases the consumer touch data characterizes interactions between a plurality of marketers and a plurality of consumers. In some cases the marketing segment detection process further comprises (a) generating a first bar chart illustrating the coefficient for a plurality of market segment variables; and (b) generating a second bar chart illustrating the collection of attribution parameters for a particular market segment that is defined by one of the plurality of market segment variables. In some cases (a) the collection of attribution parameters are expressed in terms of a percentage; and (b) a sum of the attribution parameters for the plurality of marketing channels used to interact with consumers in a particular market segment is 100%.

The foregoing detailed description has been presented for illustration. It is not intended to be exhaustive or to limit the disclosure to the precise form described. Many modifications and variations are possible in light of this disclosure. Therefore it is intended that the scope of this application be limited not by this detailed description, but rather by the claims appended hereto. Future filed applications claiming priority to this application may claim the disclosed subject matter in a different manner, and may generally include any set of one or more limitations as variously disclosed or otherwise demonstrated herein.

What is claimed is:

1. A method for evaluating the incremental effect of a marketing channel, the method comprising:
receiving consumer touch data that characterizes interactions between at least one marketer and a plurality of consumers, wherein each of the interactions are associated with at least one of a plurality of marketing channels;
receiving consumer response data that characterizes an outcome of each of the interactions in terms of a conversion parameter;
generating a statistical model that is configured to determine a conversion probability as a function of a vector of a subset of the interactions, wherein the statistical model is based on the consumer touch data and the consumer response data; and
for a particular one of the plurality of marketing channels, determining an attribution parameter based on a first conversion probability predicated on inclusion of the particular marketing channel in the vector and a second conversion probability predicated on exclusion of the particular marketing channel from the vector, wherein the first and second conversion probabilities are calculated based on the statistical model.

2. The method of claim 1, wherein the consumer touch data and the consumer response data are received from a campaign management server configured to deliver marketing assets to the plurality of consumers via the plurality of marketing channels.

3. The method of claim 1, wherein the consumer touch data and the consumer response data are received concurrently.

4. The method of claim 1, wherein:
the outcome of each of the interactions is further characterized by a revenue value; and
the statistical model is further configured to determine an expected revenue as a function of the vector.

5. The method of claim 1, wherein:
the conversion parameter is a binary parameter that indicates whether a particular consumer placed an order; and
the outcome of each of the interactions is further characterized by a revenue value.

6. The method of claim 1, wherein the statistical model is selected from a group consisting of logistic regression, random forests ensemble learning, and Cox proportional hazards model.

7. The method of claim 1, wherein:
the attribution parameter is expressed in terms of an attribution percentage; and
the attribution parameter is determined for each one of the plurality of marketing channels.

8. The method of claim 1,
wherein the outcome of each of the interactions is further characterized by a revenue value;
wherein the statistical model is further configured to determine an expected revenue as a function of the vector of a subset of the interactions; and
further comprising, for a particular one of the plurality of marketing channels, determining a revenue attribution parameter based on a difference between a first expected revenue predicated on inclusion of the particular marketing channel in the vector and a second expected revenue predicated on exclusion of the particular marketing channel from the vector, wherein the first and second expected revenues are calculated based on the statistical model.

9. The method of claim 1,
wherein each of the consumers belongs to at least one of a plurality of market segments;
wherein the plurality of market segments are collectively defined by a market segment variable;
wherein a collection of attribution parameters are determined for each of the market segments; and
further comprising determining a Akaike information criterion coefficient that correlates the market segment variable with an extent to which the collection of attribution parameters varies for the different market segments defined by the market segment variable.

10. A system for attributing consumer behavior to a marketing channel, the system comprising:
a channel attribution module configured to
generate a statistical model that is configured to determine a conversion probability as a function of a vector of marketer-consumer interactions, wherein the vector is associated with a plurality of marketing channels through which the interactions are communicated, and
determine a plurality of attribution parameters, each of which is based on a difference between a first conversion probability predicated on inclusion of a particular marketing channel in the vector and a second conversion probability predicated on exclusion of the particular marketing channel from the vector; and
a segment detection module configured to determine a coefficient that correlates a market segment variable with fluctuations in the determined attribution parameters amongst market segments that are defined by the market segment variable.

11. The system of claim 10, wherein the statistical model is further configured to determine an expected revenue as a function of the vector of marketer-consumer interactions.

12. The system of claim 10, wherein the channel attribution module and the segment detection module form part of a campaign analysis server that is configured to receive consumer touch data that characterizes the marketer-consumer interactions.

13. The system of claim 10, further comprising a user interface module configured to generate a bar chart illustrating the coefficient for a plurality of marketing segment variables.

14. The system of claim 10, further comprising a user interface module configured to receive a user query that identifies a plurality of marketing segment variables for which the coefficients are to be determined.

15. The system of claim 10, wherein the coefficient is an Akaike information criterion coefficient.

16. A computer program product encoded with instructions that, when executed by one or more processors, cause a marketing segment detection process to be carried out, the marketing segment detection process comprising:
receiving consumer touch data that characterizes interactions between a marketer and a plurality of consumers, wherein each of the interactions is associated with at least one of a plurality of marketing channels, wherein each of the consumers belongs to at least one of a plurality of market segments, and wherein the plurality of market segments are collectively defined by a market segment variable;
receiving consumer response data that characterizes an outcome associated with each of the interactions in terms of a conversion parameter;
for each of the market segments, determining a collection of attribution parameters, wherein each of the attribution parameters represents an extent to which the outcome is attributed to each of the marketing channels; and
determining a coefficient that correlates the market segment variable with an extent to which the collection of attribution parameters varies for the market segments defined by the market segment variable.

17. The computer program product of claim 16, wherein:
the consumer response data further characterizes the outcome associated with each of the interactions in terms of revenue generated; and
for each of the market segments, determining a second collection of attribution parameters, wherein each of the attribution parameters in the second collection represents an extent to which the revenue generated is attributed to each of the marketing channels.

18. The computer program product of claim 16, wherein the consumer touch data characterizes interactions between a plurality of marketers and a plurality of consumers.

19. The computer program product of claim 16, wherein the marketing segment detection process further comprises:
generating a first bar chart illustrating the coefficient for a plurality of market segment variables; and
generating a second bar chart illustrating the collection of attribution parameters for a particular market segment that is defined by one of the plurality of market segment variables.

20. The computer program product of claim 16, wherein:
the collection of attribution parameters are expressed in terms of a percentage; and
a sum of the attribution parameters for the plurality of marketing channels used to interact with consumers in a particular market segment is 100%.
